(19) United States
(12) Patent Application Publication
(10) Pub. No.: US 2009/0015440 A1
(43) Pub. Date: Jan. 15, 2009

(54) Computer keyboard mat

(76) Inventors: Julia Dante Patterson, River Vale, NJ (US); Bruce Dennis Patterson, River Vale, NJ (US); Laura Patterson St. John, Dillon, CO (US); Scott Douglas St. John, Dillon, CO (US); Katherine Mary Dunne, Hillsdale, NJ (US); David Michael Dunne, Hillsdale, NJ (US)

Correspondence Address: I to the Future, Ltd dba Imagine Tomorrow, PO Box 206, Park Ridge, NJ, 07656, US

(21) Appl. No.: 12/216,859

(22) Filed: Jul. 11, 2008

Related U.S. Application Data
(60) Provisional application No. 60/949,559, filed on Jul. 13, 2007.

(51) Int. Cl. H01H 13/807

(52) U.S. Cl. 341/34

(57) ABSTRACT

The invention is a flexible mat that can be placed on a floor or other large flat surface for the purpose of serving as a fully functional, oversized membrane computer keyboard with enlarged characters and keypad area. Each character depicted on the keyboard indicates a particular letter, numeral, function or symbol for input. Thereby, its user can enter information into a computer or electronic device through the keyboard by using alternative methods of input to traditional finger keystrokes. Rather, the user may utilize feet, knees, hands or other body parts and non-body parts instead of only fingers.

### CROSS REFERENCE TO RELATED APPLICATIONS

This application claims the benefit of provisional application No. 60/949,559 filed on 13 Jul. 2007.

### STATEMENT REGARDING FEDERALLY SPONSORED RESEARCH OR DEVELOPMENT

Not Applicable

### THE NAMES OF THE PARTIES TO A JOINT RESEARCH AGREEMENT Not Applicable

### INCORPORATION-BY-REFERENCE OF MATERIAL SUBMITTED ON A COMPACT DISC

Not Applicable

### BACKGROUND OF THE INVENTION

### References Cited

### U.S. Patent Documents

| | | |
|---|---|---|
| 3600528 | August 1971 | Leposavic |
| 5164558 | November 1992 | Huff et al. |
| 5220521 | June 1993 | Kikinis |

(1) Field of the Invention

The field of the invention is electronic device input, more specifically methods, systems and products for input and navigation of a computer or device capable of processing and displaying data.

(2) Description of Related Art

The origin of the modem computer keyboard began with the invention of the typewriter in 1867. The industry standard keyboard layout is the QWERTY keyboard because of the arrangement of the keys in the upper row. When electric typewriters and computers were developed, the typewriter QWERTY layout was retained even though the keys were connected to electrical switches rather than mechanical typing mechanisms. In particular, the keyboards were designed to repeatedly input any key that is held down.

As computers and electric typewriters advanced, the keyboard layouts also changed. In addition to the letter and number keys, special function keys were added to control various computer program functions. Cursor keys that control the cursor position and a numeric keypad for faster numeric input were also added to computer keyboards.

Due to the growing applications of computer technology in society, familiarity with technology at a young age has significant educational and social benefits. As a result, pre-reading and early reading skills as well as cause and effect relationships associated with computer input and outcomes has shifted the need for technological comprehension downward in the ages of users.

Oftentimes, youngsters have not attained the fine motor skills necessary for the intricacies associated with a standard keyboard and mouse though they have the mental capacity to become engaged with software. Larger input keys and larger navigation controls are a solution for youngsters, especially when delivered on a large membrane keyboard that is durable and easily accessible because of its positioning on the floor. Contributing factors such as membrane style keyboard, oversized input keys and flexible mat design offer users alternatives to traditional finger keystroke input. Users can utilize more than their fingers to depress key controls such as, but not limited to hands, elbows, knees, and feet.

Additionally, input through traditional keyboard entry is a physically passive measure even with the evolution of multimedia software that incorporates sight and sound. This sedentary means of interaction has been studied as a contributor to the growing trend of obesity and lack of physical fitness in youth. The oversized keyboard requires the user to physically move and change their body position in order to utilize the input keys, resulting in more physical energy exerted and calories burned then traditional input means.

### BRIEF SUMMARY OF THE INVENTION

The invention is a fully functional, oversized flexible and resilient non-conductive plastic or polymeric material membrane keyboard with oversized keys that is intended to help children use computers and other electronic devices in order to attain not only the benefits of technological know how, productivity, communication, entertainment and academic expansion, but also the therapeutic and health benefit associated with low impact physical activity.

The oversized keyboard mat and subsequent oversized keys of the keyboard mat enable the user to initiate electronic device input through alternative means of data entry and navigation in addition to traditional finger tips pressing on keys as is common with standard keyboards. Because of the oversized nature of the keyboard and the ability to place it on non traditional surfaces such as the floor and large flat surfaces, alternative means of input that don't require fingers or fine motor skills become available. Additionally, because of the enlarged size of the mat, the user is required to physically move from one key to another to attain input. This physical activity is also a direct goal of the keyboard mat in providing low impact physical activity to its user. This lends itself to a multitude of educational uses where the goal of the enlarged keyboard is to engage multiple senses through a full body physical experience. Additionally, the mat lends itself to handicap related applications where physical and mental barriers would isolate potential users from using a traditional keyboard and mouse.

The flexible and resilient plastic material construction allows for a flat profile when placed on a flat surface. Thus, reducing the likelihood of injury by its user when the keys are pressed with alternative body parts and objects. For example, the flat profile reduces the likeliness of a twisted ankle. Also, the flexible material is an advantage for storage since the mat can be rolled or folded into a more compact size and easily stored when not in use. The plastic material is also water and moisture resistant, creating an impervious layer to fluids that could damage the internal electronic switches.

### BRIEF SUMMARY OF THE SEVERAL VIEWS OF THE DRAWING

FIG. 1—A top view of the keyboard with approximate overall dimensions

FIG. 2—A cut away view exposing the various layers

FIG. 3—A side view exposing the various layers and low profile

### DETAILED DESCRIPTION OF THE INVENTION

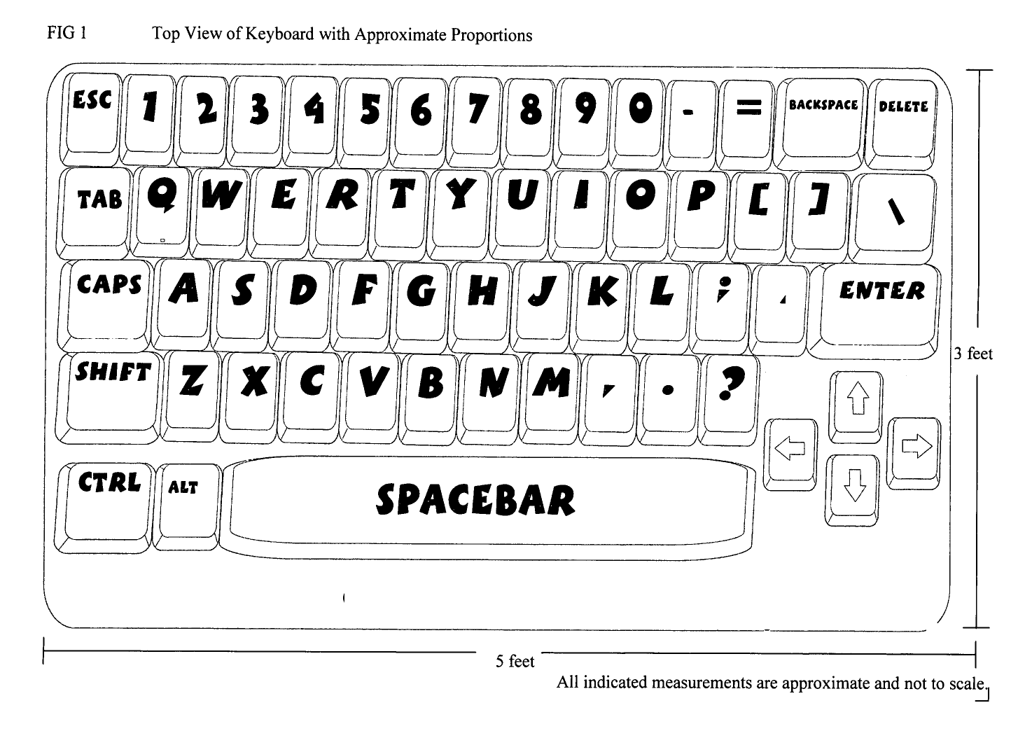

The present invention is a keyboard designed for children and those who seek alternative physical means for computer input. With reference to FIG. 1, the inventive keyboard uses the standard QWERTY layout but includes several design features that allow the keyboard to be more easily used by children. Various features differentiate the inventive keyboard from existing keyboards. The inventive keyboard is oversized, approximately 5 feet long by 3 feet wide. It contains oversized keypad areas containing an effective area of approximately 8 inches long by 5 inches wide for standard character keypad areas and variations thereof for function keys.

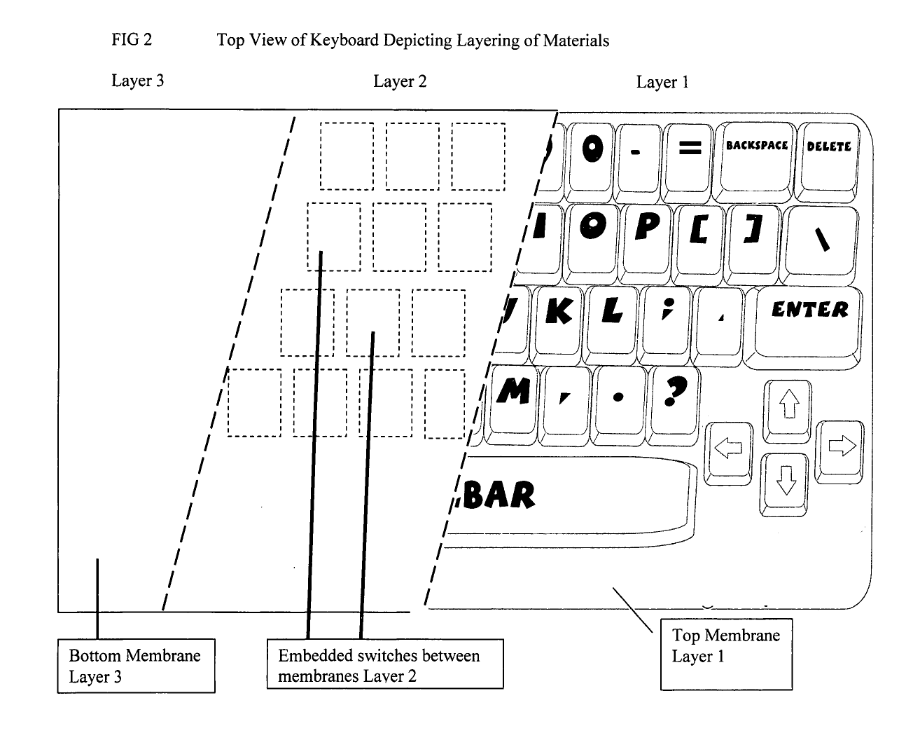

With reference to FIG. 2, the inventive keyboard uses membrane keyboard technology. In this adaptation the stand-alone pressure sensitive switches are embedded between two layers of flexible plastic bearing a side profile of less than ½ inch. The switches correspond to characters and function keypads that are represented on the outside facing surface of the top layer of flexible plastic. Activated switches input that character or function to a computer or electronic device capable of accepting electronic input that then displays that input command on its monitor through corresponding software. The effective pressure sensitive area of each individual switch is approximately 8 inches long by 5 inches wide for standard character keys and corresponding variations for function keys. The diagram offers explanation of the layering sequence of the plastic and switches that comprise the mat and illustrates the proportional effective area of the imbedded switches.

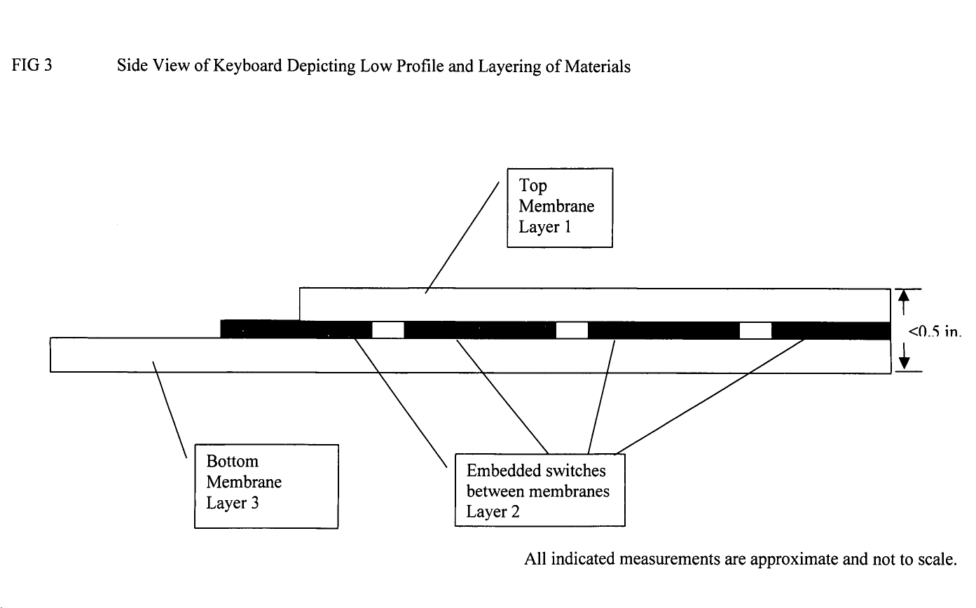

FIG. 3 is a side view of the oversized, flexible keyboard mat illustrating the layering sequence of the plastic and switches.

1. An oversized flexible computer keyboard with oversized character keypads using membrane keyboard technology comprising: a pair of overlying upper and lower flexible plastic membranes; a plurality of discrete self-contained pressure sensitive switches each being embedded between but otherwise independent of said flexible plastic membranes and comprising an individual key of the keyboard. Each of the switches is actuated by engagement through applied pressure to the upper surface to generate a predetermined output.

2. The computer keyboard in claim 1, maintains a low side profile in order to be laid on the floor or other large, flat, surface in order to be engaged by its user.
